(19) United States
(12) Patent Application Publication
(10) Pub. No.: US 2023/0091746 A1
(43) Pub. Date: Mar. 23, 2023

(54) TOUGHENED THERMOSET RESIN COMPOSITIONS

(71) Applicant: Huntsman Advanced Materials Americas LLC, The Woodlands, TX (US)

(72) Inventors: Dong LE, The Woodlands, TX (US); Derek KINCAID, The Woodlands, TX (US); David JOHNSON, The Woodlands, TX (US)

(21) Appl. No.: 17/800,813

(22) PCT Filed: Feb. 17, 2021
(86) PCT No.: PCT/US2021/018345

§ 371 Date: Aug. 18, 2022

Related U.S. Application Data
(60) Provisional application No. 62/979,815, filed on Feb. 21, 2020.

(51) Int. Cl. C08L 63/00

(52) U.S. Cl. CPC C08L 63/00; C08L 2205/035

(57) ABSTRACT

The present disclosure provides a curable resin composition including a thermoset resin, a toughener component containing a multistage polymer and a thermoplastic toughener and a hardener. The curable resin composition may be combined with reinforcing fibers and then cured to form a fiber-reinforced composite article having a high glass transition temperature and excellent mechanical properties. The fiber-reinforced composite article may be used in various applications, such as in transport applications including aerospace, aeronautical, nautical and land vehicles.

### CROSS-REFERENCE TO RELATED APPLICATION

This application claims the benefit of U.S. Provisional Patent Application Ser. No. 62/979,815, filed Feb. 21, 2020, the entire contents of which are expressly incorporated herein by reference.

### FIELD

The present disclosure generally relates to curable resin compositions having a high glass transition temperature and enhanced toughness resistance. In particular, the present disclosure relates to a curable resin composition containing a thermoset resin, a toughener component containing a multistage polymer and a thermoplastic toughener, and a hardener. The present disclosure also relates to the use of such curable resin compositions which may be cured in the presence of reinforcing fibers to form fiber-reinforced composite articles, and to aerospace structural parts made from the fiber-reinforced composite articles.

### BACKGROUND

Thermoset materials, such as cured epoxy resins, are known for their thermal and chemical resistance. They also display good mechanical properties, but frequently lack toughness and tend to be very brittle. This is especially true as their crosslink density increases or the monomer functionality increases above two. Attempts have been made to strengthen or toughen epoxy resins and other thermoset materials, such as bismaleimide resins, benzoxazine resins, cyanate ester resins, epoxy vinyl ester resins and unsaturated polyester resins, by incorporating therein a variety of toughener materials.

Such tougheners may be compared to one other by their structural, morphological, or thermal properties. The structural backbone of the toughener may be aromatic, aliphatic, or both aromatic and aliphatic. Aromatic tougheners, such as polyether ether ketone or polyimides, provide thermoset materials which exhibit reasonable improvements in toughening, namely compression after impact and, because of the aromatic structure of the toughener, low moisture uptake when subjected to hot-wet environments. Conversely, aliphatic tougheners, such as nylon (a.k.a. polyamide), provide thermoset materials which exhibit a significant improvement in compression after impact but higher than desired moisture uptake when subjected to hot-wet environments which can lead to a diminishment in compression strength and compression modulus. Other tougheners, such as core-shell polymers, can provide thermoset materials which exhibit good damage resistance. However, these tougheners tend to negatively affect the processability and glass transition temperature of the thermoset material.

One particular toughener which has found use recently in thermoset resin compositions is a multistage polymer, such as those described in WO2016102666, WO2016102658, WO2016102682, WO2017211889, WO2017220793, WO2018002259 and WO2019012052. While these tougheners have been found to be easily dispersed in the thermoset matrix to provide a homogeneous distribution, the cured products can still lack adequate toughness, especially when curing at elevated temperatures during resin infusion processing in connection with primary structural applications.

Therefore, a need exists to further improve upon the state of the art by utilizing a new toughener component with thermoset materials that, upon curing, allows the cured product to exhibit a high glass transition temperature and high compression after impact.

### SUMMARY

The present disclosure generally provides a curable resin composition including (a) a thermoset resin, (b) a toughener component comprising a multistage polymer and a thermoplastic toughener, and (c) a hardener. The present disclosure also provides a fiber-reinforced resin composition including reinforcing fibers and the curable resin composition of the present disclosure. The fiber-reinforced resin composition may be cured to form a fiber-reinforced composite article which may find use in a variety of applications, such as in transport applications (including aerospace, aeronautical, nautical and land vehicles, and including the automotive, rail, coach and military industries), in building/construction applications or in other commercial applications.

### DETAILED DESCRIPTION

The present disclosure generally provides a curable resin composition comprising (a) a thermoset resin, (b) a toughener component comprising a multistage polymer and a thermoplastic toughener, and (c) a hardener. Although the curable resin composition may be used alone, the composition may be combined with reinforcing fibers to form a fiber-reinforced resin composition and cured to form a fiber-reinforced composite article. It has been unexpectedly found that the combination of the multistage polymer and the thermoplastic toughener act synergistically so that the toughening effect observed is greater than what would be expected from the cumulative toughening effect of the multistage polymer and thermoplastic toughener. For example, it has been surprisingly found that the combination of the multistage polymer and thermoplastic toughener may allow the composite article to display chemical and mechanical properties that are especially suitable for primary and secondary aerospace structural applications as well as structural materials in other moving bodies including cars, boats and railway carriages. Notably, the fiber-reinforced composite article exhibits a higher compression after impact (CAI) as compared to fiber-reinforced composites particles containing a multistage polymer or thermoplastic toughener alone in addition to also exhibiting a glass transition temperature of at least 190° C.

The following terms shall have the following meanings:

The term “cure”, “cured” or similar terms, “curing” or “cure” refers to the hardening of a thermoset resin by chemical cross-linking. The term “curable” means that the composition is capable of being subjected to conditions which will render the composition to a cured or thermoset state or condition.

The term “multistage polymer” refers to a polymer formed in sequential fashion by a multistage polymerization process. The multistage polymerization process may be a multistage emulsion polymerization process in which a first polymer is a first stage polymer and the second polymer is a second stage polymer (i.e., the second polymer is formed by emulsion polymerization in the presence of the first emulsion polymer).

The term “(meth)acrylic polymer” denotes a polymer comprising 50 wt. % or more of (meth)acrylic monomers based on the total weight of the polymer.

The term “(meth)acrylic”, as used herein, denotes all kinds of acrylic and methacrylic monomers.

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “an epoxy resin” means one epoxy resin or more than one epoxy resin.

The phrases “in one embodiment”, “according to one embodiment” and the like generally mean the particular feature, structure, or characteristic following the phrase is included in at least one aspect of the present disclosure, and may be included in more than one embodiment of the present disclosure. Importantly, such phases do not necessarily refer to the same embodiment.

If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

According to a first embodiment, the present disclosure provides a curable resin composition that generally includes (a) a thermoset resin, (b) a toughener component comprising a multistage polymer and a thermoplastic toughener, and (c) a hardener.

In one embodiment, the thermoset resin may be an epoxy resin, a bismaleimide resin, a benzoxazine resin, a cyanate ester resin, a phenolic resin, a vinyl ester resin or a mixture thereof. In one particular embodiment, the thermoset resin is an epoxy resin.

In general, any epoxy-containing compound is suitable for use as the epoxy resin in the present disclosure, such as the epoxy-containing compounds disclosed in U.S. Pat. No. 5,476,748 which is incorporated herein by reference. According to one embodiment, the epoxy resin is selected from a difunctional epoxy resin (thus having two epoxide groups), a trifunctional epoxy resin (thus having three epoxide groups), a tetrafunctional epoxy resin (thus having four epoxide groups) and a mixture thereof.

Illustrative non-limiting examples of difunctional epoxy resins are: bisphenol A diglycidyl ether, bisphenol F diglycidyl ether, tetrabromobisphenol A diglycidyl ether, propylene glycol diglycidyl ether, butylene glycol diglycidyl ether, ethylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, 3,4-epoxycyclohexylmethyl carboxylate, hexahydrophthalic acid diglycidyl ester, methyltetrahydrophthalic acid diglycidyl ester and mixtures thereof. In some embodiments, the difunctional epoxy resin may be modified with a monofunctional reactive diluent, such as, but not limited to, p-tertiary butyl phenol glycidyl ether, cresyl glycidyl ether, 2-ethylhexyl glycidyl ether, and C8- C14 glycidyl ether.

Illustrative non-limiting examples of trifunctional epoxy resins are: triglycidyl ether of para-aminophenol, triglycidyl ether of meta-aminophenol, dicyclopentadiene based epoxy resins, N,N,O-triglycidyl-4-amino-m- or -5-amino-o-cresol type epoxy resins, and a 1,1,1-(triglycidyloxyphenyl)methane type epoxy resin.

Illustrative non-limiting examples of tetrafunctional epoxy resins are: N,N,N′,N′-tetraglycidyl methylene dianiline, N,N,N′,N′-tetraglycidyl-m-xylenediamine, tetraglycidyl diaminodiphenyl methane, sorbitol polyglycidyl ether, pentaerythritol tetraglycidyl ether, tetraglycidyl bisamino methyl cyclohexane and tetraglycidyl glycoluril.

Examples of commercially available epoxy resins which may be used include, but are not limited to, ARALDITE® PY 306 epoxy resin (an unmodified bisphenol-F based liquid epoxy resin), ARALDITE® MY 721 epoxy resin (a tetrafunctional epoxy resin based on methylene dianiline), ARALDITE® MY 0510 epoxy resin (a trifunctional epoxy resin based on para-aminophenol), ARALDITE® GY 6005 epoxy resin (a bisphenol-A based liquid epoxy resin modified with a monofunctional reactive diluent), ARALDITE® 6010 epoxy resin (a bisphenol-A based liquid epoxy resin), ARALDITE® MY 06010 epoxy resin (a trifunctional epoxy resin based on meta-aminophenol), ARALDITE® GY 285 epoxy resin (an unmodified bisphenol-F based liquid epoxy resin), ARALDITE® EPN 1138, 1139 and 1180 epoxy resins (epoxy phenol novolac resins), ARALDITE® ECN 1273 and 9611 epoxy resins (epoxy cresol novolac resins), ARALDITE® GY 289 epoxy resin (an epoxy phenol novolac resin), ARALDITE® PY 307-1 epoxy resin (an epoxy phenol novolac resin) and mixtures thereof.

In one embodiment, the amount of the epoxy resin present in the curable resin composition may be an amount of between about 10 wt. % to about 90 wt. %, or between about 20 wt. % to about 75 wt. %, or between about 30 wt. % to about 60 wt. %, or between about 40 wt. % to about 50 wt. %, based on the total weight of the curable resin composition. In another embodiment, the amount of the epoxy resin present in the curable resin composition may be an amount of between about 50 wt. % to about 95 wt. %, or between about 65 wt. % to about 90 wt. %, based on the total weight of the curable resin composition.

In yet another embodiment, the epoxy resin may be comprised of at least one trifunctional epoxy resin or tetrafunctional epoxy resin or mixture thereof and optionally at least one difunctional epoxy resin. In such embodiments, the trifunctional epoxy resin may be present in the curable resin composition in an amount of between about 25 wt. % to about 50 wt. %, or between about 35 wt. % to 45 wt. %, based on the total weight of the curable resin composition and the tetrafunctional epoxy resin may be present in the curable resin composition in an amount of between about 1 wt. % to 20 wt. %, or between about 5 wt. % to about 15 wt. % based on the total weight of the curable resin composition.

According to another embodiment, the thermoset resin is a benzoxazine resin. The benzoxazine resin may be any curable monomer, oligomer or polymer containing at least one benzoxazine moiety. Thus, in one embodiment, the benzoxazine may be represented by the general formula (1)

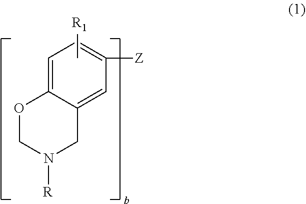

where b is an integer from 1 to 4; each R is independently hydrogen, a substituted or unsubstituted C₁-C₂₀ alkyl group, a substituted or unsubstituted C₂-C₂₀ alkenyl group, a substituted or unsubstituted C₆-C₂₀ aryl group, a substituted or unsubstituted C₂-C₂₀ heteroaryl group, a substituted or unsubstituted C₄-C₂₀ carbocyclic group, a substituted or unsubstituted C₂-C₂₀ heterocyclic group, or a C₃-C₈ cycloalkyl group; each R₁ is independently hydrogen, a C₁-C₂₀ alkyl group, a C₂-C₂₀ alkenyl group, or a C₆-C₂₀ aryl group; and Z is a direct bond (when b=2), a substituted or unsubstituted C₁-C₂₀ alkyl group, a substituted or unsubstituted C₆-C₂₀ aryl group, a substituted or unsubstituted C₂-C₂₀ heteroaryl group, O, S, S═O, O═S═O or C═O. Substituents include, but are not limited to, hydroxy, a C₁-C₂₀ alkyl group, a C₂-C₁₀ alkoxy group, mercapto, a C₃-C₈ cycloalkyl group, a C₆-C₁₄ heterocyclic group, a C₆-C₁₄ aryl group, a C₆-C₁₄ heteroaryl group, halogen, cyano, nitro, nitrone, amino, amido, acyl, oxyacyl, carboxyl, carbamate, sulfonyl, sulfonamide, and sulfuryl.

In a particular embodiment within formula (1), the benzoxazine may be represented by the following formula (1a)

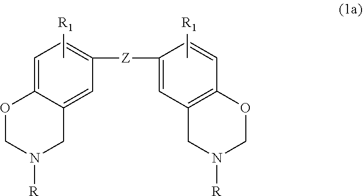

where Z is selected from a direct bond, CH₂, C(CH₃)₂, C═O, O, S, S═O, O═S═O and

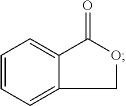

each R is independently hydrogen, a C₁-C₂₀ alkyl group, an allyl group, or a C₆-C₁₄ aryl group; and R₁ is defined as above.

In another embodiment, the benzoxazine may be embraced by the following general formula (2)

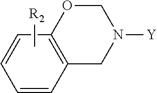

where Y is a C₁-C₂₀ alkyl group, a C₂-C₂₀ alkenyl group, or substituted or unsubstituted phenyl; and each R₂ is independently hydrogen, halogen, a C₁-C₂₀ alkyl group, a C₂-C₂₀ alkenyl group or a C₆-C₂₀ aryl group. Suitable substituents for phenyl are as set forth above.

In a particular embodiment within formula (2), the benzoxazine may be represented by the following formula (2a)

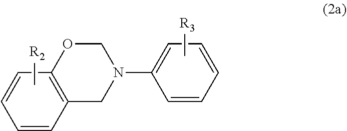

where each R₂ is independently a C₁-C₂₀ alkyl or C₂-C₂₀ alkenyl group, each of which being optionally substituted or interrupted by one or more O, N, S, C═O, COO and NHC═O, and a C₆-C₂₀ aryl group; and each R₃ is independently hydrogen, a C₁-C₂₀ alkyl or C₂-C₂o alkenyl group, each of which being optionally substituted or interrupted by one or more O, N, S, C═O, COOH and NHC═O or a C₆-C₂₀ aryl group.

Alternatively, the benzoxazine may be embraced by the following general formula (³)

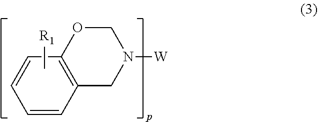

where p is 2; W is selected from biphenyl, diphenyl methane, diphenyl isopropane, diphenyl sulfide, diphenyl sulfoxide, diphenyl sulfone, and diphenyl ketone; and R¹ is defined as above.

The benzoxazines are commercially available from several sources including Huntsman Advanced Materials Americas LLC, Georgia Pacific Resins Inc. and Shikoku Chemicals Corporation.

The benzoxazines may also be obtained by reacting a phenol compound, for example, bisphenol A, bisphenol F or phenolphthalein, with an aldehyde, for example, formaldehyde, and a primary amine, under conditions in which water is removed. The molar ratio of phenol compound to aldehyde reactant may be from about 1:3 to 1:10, alternatively from about 1:4: to 1:7. In still another embodiment, the molar ratio of phenol compound to aldehyde reactant may be from about 1:4.5 to 1:5. The molar ratio of phenol compound to primary amine reactant may be from about 1:1 to 1:3, alternatively from about 1:1.4 to 1:2.5. In still another embodiment, the molar ratio of phenol compound to primary amine reactant may be from about 1:2.1 to 1:2.2.

Examples of primary amines include: aromatic mono- or di-amines, aliphatic amines, cycloaliphatic amines and heterocyclic monoamines, for example, aniline, o-, m- and p-phenylene diamine, benzidine, 4,4′-diaminodiphenyl methane, cyclohexylamine, butylamine, methylamine, hexylamine, allylamine, furfurylamine ethylenediamine, and propylenediamine. The amines may, in their respective carbon part, be substituted by C₁-C₈ alkyl or allyl. In one embodiment, the primary amine is a compound having the general formula RₐNH2, wherein Rₐ is allyl, unsubstituted or substituted phenyl, unsubstituted or substituted C₁-C₈ alkyl or unsubstituted or substituted C₃-C₈ cycloalkyl. Suitable substituents on the Rₐ group include, but are not limited to, amino, C₁-C₄ alkyl and allyl. In some embodiments, one to four substituents may be present on the Rₐ group. In one particular embodiment, Rₐ is phenyl.

According to one embodiment, the benzoxazine may be present in the curable composition in an amount in the range of between about 10 wt. % to about 90 wt. %, based on the total weight of the curable composition. In another embodiment, the benzoxazine may be present in the curable composition in an amount in the range of between about 60 wt. % to about 90 wt. %, based on the total weight of the curable composition.

The curable resin composition also includes a toughener component comprising a multistage polymer and a thermoplastic toughener.

The multistage polymer (for e.g. as described in WO2016/102411 and WO2016/102682, the contents of which are incorporated herein by reference) has at least two stages that are different in its polymer composition where the first stage forms the core and the second or all following stages form the respective shells. The multistage polymer may be in the form of polymer particles, especially spherical particles. These polymer particles are also called core shell particles with the first stage forming the core and the second or all following stages forming the respective shells. In one embodiment, the polymer particles may have a weight average particle size between 20 nm and 800 nm, or between 25 nm and 600 nm, or between 30 nm and 550 nm or between 40 nm and 400 nm or between 75 nm and 350 nm or between 80 nm and 300 nm. The polymer particles may be agglomerated to provide a polymer powder.

Thus, the polymer particles may have a multilayer structure including at least one layer (or stage) (A) comprising a polymer (A1) having a glass transition temperature below about 10° C., and at least another layer (or stage) (B) comprising a polymer (B1) having a glass transition temperature over about 30° C. In some embodiments, the polymer (B1) is the external layer of the polymer particle. In other embodiments, the stage (A) comprising the polymer (A1) is the first stage and the stage (B) comprising the polymer (B1) is grafted on stage (A) comprising the polymer (A1).

As noted above, the polymer particle may be obtained by a multistage process such as a process comprising two, three or more stages. The polymer (A1) having a glass transition temperature below about 10° C. in the layer (A) is never made during the last stage of the multistage process. This means that the polymer (A1) is never in the external layer of the particle. Accordingly, the polymer (A1) having a glass transition temperature below about 10° C. in the layer (A) is either in the core of the polymer particle or one of the inner layers.

In some embodiments, the polymer (A1) having a glass transition temperature below about 10° C. in the layer (A) is made in the first stage of the multistage process forming the core for the polymer particle having the multilayer structure and/or before the polymer (B1).

In other embodiments, the polymer (B1) having a glass transition temperature above about 30° C. is made in the last stage of the multistage process forming the external layer of the polymer particle. There could be additional intermediate layer or layers obtained by an intermediate stage or intermediate stages.

In one embodiment, at least a part of the polymer (B1) of layer (B) is grafted on the polymer made in the previous layer. If there are only two stages (A) and (B) comprising polymer (A1) and (B1) respectively, a part of polymer (B1) is grafted on polymer (A1). In some embodiments, at least 50 wt. % of polymer (B1) is grafted.

According to one embodiment, the polymer (A1) is a (meth)acrylic polymer.

In further embodiments, the polymer (A1) comprises a comonomer or comonomers which are copolymerizable with an alkyl acrylate, as long as polymer (A1) has a glass transition temperature of less than about 10° C. The comonomer or comonomers in polymer (A1) may be chosen from (meth)acrylic monomers and/or vinyl monomers. The (meth)acrylic monomers may comprise monomers chosen from C₁ to C₁₂ alkyl (meth)acrylates. In still other embodiments, the polymer (A1) includes monomers of C₁ to C₄ alkyl (meth)acrylate and C₁ to C₈ alkyl acrylate monomers. Most preferably, the monomers of the polymer (A1) are chosen from methyl acrylate, propyl acrylate, isopropyl acrylate, butyl acrylate, tert-butyl acrylate, methyl methacrylate, ethyl methacrylate, butyl methacrylate and mixtures thereof, as long as polymer (A1) has a glass transition temperature of less than about 10° C.

In another embodiment, the polymer (A1) is crosslinked (i.e., a crosslinker is added to the other monomer or monomers). The crosslinker may comprise at least two groups that can be polymerized.

In one specific embodiment, the polymer (A1) is a homopolymer of butyl acrylate. In another specific embodiment, the polymer (A1) is a copolymer of butyl acrylate and at least one crosslinker. The crosslinker may be present in an amount of less than 5 wt. % of this copolymer.

In still another embodiment, the polymer (A1) having a glass transition temperature below about 10° C. is a silicone rubber based polymer. The silicone rubber may be, for example, polydimethylsiloxane.

In still another embodiment, the polymer (A1) having a glass transition temperature below about 10° C. comprises at least 50 wt. % of polymeric units coming from isoprene or butadiene and the stage (A) is the most inner layer of the polymer particle. In other words the stage (A) comprising the polymer (A1) is the core of the polymer particle. By way of example, the polymer (A1) of the core may be made of isoprene homopolymers or butadiene homopolymers, isoprene-butadiene copolymers, copolymers of isoprene with at most 98 wt. % of a vinyl monomer and copolymers of butadiene with at most 98 wt. % of a vinyl monomer. The vinyl monomer may be styrene, an alkylstyrene, acrylonitrile, an alkyl (meth) acrylate, or butadiene or isoprene. In one embodiment the core is a butadiene homopolymer.

The polymer (B1) may be made of homopolymers and copolymers comprising monomers with double bonds and/or vinyl monomers. Preferably, the polymer (B1) is a (meth)acrylic polymer. Preferably the polymer (B1) comprises at least 70 wt. % monomers chosen from C₁ to C₁₂ alkyl (meth)acrylates. Still more preferably, the polymer (B1) comprises at least 80 wt. % of monomers of C₁ to C₄ alkyl methacrylate and/or C₁ to C₈ alkyl acrylate monomers. Most preferably, the acrylic or methacrylic monomers of the polymer (B1) are chosen from methyl acrylate, ethyl acrylate, butyl acrylate, methyl methacrylate, ethyl methacrylate, butyl methacrylate and mixtures thereof, as long as polymer (B1) has a glass transition temperature of at least about 30° C. Advantageously, the polymer (B1) comprises at least 70 wt. % of monomer units coming from methyl methacrylate.

In another embodiment, the multistage polymer as described previously has an additional stage, which is a (meth)acrylic polymer (P1). The primary polymer particle according to this embodiment will have a multilayer structure comprising at least one stage (A) comprising a polymer (A1) having a glass transition temperature below about 10° C., at least one stage (B) comprising a polymer (B1) having a glass transition temperature over about 30° C. and at least one stage (P) comprising the (meth)acrylic polymer (P1) having a glass transition temperature between about 30° C. and about 150° C. Preferably, the (meth)acrylic polymer (P1) is not grafted on any of the polymers (A1) or (B1).

The (meth)acrylic polymer (P1) may have a mass average molecular weight Mw of less than about 100,000 g/mol, or less than about 90,000 g/mol, or less than about 80,000 g/mol, or less than about 70,000 g/mol, advantageously less than about 60,000 g/mol, more advantageously less than about 50,000 g/mol and still more advantageously less than about 40,000 g/mol.

The (meth)acrylic polymer (P1) may have a mass average molecular weight Mw above about 2000 g/mol, or above about 3000 g/mol, or above about 4000g/mol, or above about 5000 g/mol, advantageously above about 6000 g/mol, more advantageously above about 6500 g/mol and still more advantageously above about 7000 g/mol and most advantageously above about 10,000 g/mol.

The mass average molecular weight Mw of (meth)acrylic polymer (P1) may be between about 2000 g/mol and about 100,000 g/mol, or between about 3000 g/mol and about 90,000 g/mol or between about 4000 g/mol and about 80,000 g/mol, advantageously between about 5000 g/mol and about 70,000 g/mol, more advantageously between about 6000 g/mol and about 50,000 g/mol and most advantageously between about 10,000 g/mol and about 40,000 g/mol .

Preferably, the (meth)acrylic polymer (P1) is a copolymer comprising (meth)acrylic monomers. Still more preferably, the (meth)acrylic polymer (P1) comprises at least 50 wt. % monomers chosen from C₁ to C₁₂ alkyl (meth)acrylates. Advantageously the (meth)acrylic polymer (P1) comprises at least 50 wt. % of monomers chosen from Ci to C₄ alkyl methacrylate and C₁ to C₈ alkyl acrylate monomers and mixtures thereof. More advantageously the (meth)acrylic polymer (P1) comprises at least 50 wt. % of polymerized methyl methacrylate, and even more advantageously at least 60 wt. % and most advantageously at least 65 wt. % of polymerized methyl methacrylate.

In one embodiment the (meth)acrylic polymer (P1) comprises from 50 wt. % to 100 wt. % methyl methacrylate, or from 80wt. % to 100 wt. % methyl methacrylate, or from 80 wt. % to 99.8 wt. % methyl methacrylate and from 0.2 wt. % to 20 wt. % of a C₁ to C₈ alkyl acrylate monomer. Advantageously the C₁ to C₈ alkyl acrylate monomer is chosen from methyl acrylate, ethyl acrylate or butyl acrylate.

In another embodiment the (meth)acrylic polymer (P1) comprises between 0.01 wt. % and 50 wt. % of a functional monomer. Preferably, the (meth)acrylic polymer (P1) comprises between 0.01 wt. % and 30 wt. % of the functional monomer, more preferably between 1 wt. % and 30 wt. %, still more preferably between 2 wt. % and 30 wt. %, advantageously between 3 wt. % and 30 wt. %, of the functional monomer.

In one embodiment, the functional monomer is chosen from glycidyl (meth)acrylate, acrylic or methacrylic acid, amides derived from acrylic or methacrylic acids, such as, for example, dimethylacrylamide, 2-methoxyethyl acrylate or methacrylate, 2-aminoethyl acrylates or methacrylates which are optionally quaternized, acrylate or methacrylate monomers comprising a phosphonate or phosphate group, alkyl imidazolidinone (meth)acrylates and polyethylene glycol (meth)acrylates. Preferably, the polyethylene glycol group of the polyethylene glycol (meth)acrylates have a molecular weight ranging from 400 g/mol to 10,000 g/mol.

The toughener component also includes a thermoplastic toughener. Any suitable thermoplastic polymer may be used as the thermoplastic toughener. Typically, the thermoplastic toughener can be added to the thermoset resin as particles that are dissolved in the resin by heating prior to addition of the hardener. Once the thermoplastic toughener is substantially dissolved in the hot resin, the resin is cooled and the remaining components (for e.g., hardener and multistage polymer) can be added and mixed with the cooled resin blend.

Exemplary thermoplastic tougheners may include any of the following thermoplastic polymers, either alone or in combination: polysulfone, polyethersulfone, polyetherimide, polyamide (PA), poly(phenylene)oxide (PPO), poly(ethylene oxide) (PEO), phenoxy, poly(methyl methacrylate) (PMMA), poly(vinylpyrrolidone) (PVP), poly(ether ether ketone) (PEEK), poly(styrene) (PS) and polycarbonate (PC).

According to one embodiment, the thermoplastic toughener is polyethersulfone. Non-limiting examples of polyethersulfones include particulate polyethersulfones sold under the brand name Sumnikaexcel® polyethersulfones which are commercially available from Sumitomo Chemicals, and those sold under the brand names Veradel® and Virantage® polyethersulfones which are commercially available from Solvay Chemicals. Densified polyethersulfone particles may also be used. The form of the polyethersulfone is not particularly important since the polyethersulfone can be dissolved during formation of the curable resin composition. Densified polyethersulfone particles can be made in accordance with the teachings of U.S. Pat. No. 4,945,154, the contents of which are hereby incorporated by reference. Densified polyethersulfone particles are also available commercially from Hexcel Corporation under the brand name HRI-1. In some embodiments, the average particle size of the polyethersulfone is less than 100 microns to promote and ensure complete dissolution of the polyethersulfone in the thermoset resin.

According to one embodiment, the amount of the toughener component present in the curable resin composition is less than about 25 wt. %, based on the total weight of the curable resin composition. In another embodiment, the amount of the toughener component present in the curable resin composition is less than about 22.5 wt. %, or less than about 20 wt. %, or less than about 17.5 wt. % or less than about 15 wt. %, based on the total weight of the curable resin composition. According to another embodiment, the amount of the toughener component present in the curable resin composition is at least about 1 wt. %, or at least about 5 wt. % or at least about 7.5 wt. %, based on the total weight of the curable resin composition. In still another embodiment the amount of the toughener component present in the curable resin composition is between about 1 wt. % to about 25 wt. %, or between about 5 wt. % to about 20 wt. % or between about 7 wt. % to about 16 wt. %, based on the total weight of the curable resin composition.

According to another embodiment, the amount of multistage polymer present in the curable resin composition is between about 3 wt. % to about 20 wt. %, or between about 5 wt. % to about 15 wt. %, or between about 7 wt. % to about 13 wt. %., based on the total weight of the curable resin composition. In still another embodiment, the amount of thermoplastic toughener present in the curable resin mixture is between about 0.1 wt. % to about 10 wt. %, or between about 0.1 wt. % to about 7 wt. %, or between about 0.1 wt. % to about 5 wt. %, based on the total weight of the curable resin composition.

Hardening of the curable resin composition may be accomplished by the addition of any chemical material(s) known in the art for curing the thermoset resin. Such materials are compounds that have a reactive moiety that can react with the reactive group of the thermoset resin and are referred to herein as “hardeners” but also include the materials known to those skilled in the art as curing agents, curatives, activators, catalysts or accelerators. While certain hardeners promote curing by catalytic action, others participate directly in the reaction of the thermoset resin and are incorporated into the thermoplastic polymeric network formed by condensation, chain-extension and/or cross-linking of the thermoset resin. Depending on the hardener, heat may or may not be required for significant reaction to occur. Hardeners for the thermoset resin include, but are not limited to aromatic amines, cyclic amines, aliphatic amines, alkyl amines, polyether amines, including those polyether amines that can be derived from polypropylene oxide and/or polyethylene oxide, 9,9-bis(4-amino-3-chlorophenyl)fluorene (CAF), acid anhydrides, carboxylic acid amides, polyamides, polyphenols, cresol and phenol novolac resins, imidazoles, guanidines, substituted guanidines, substituted ureas, melamine resins, guanamine derivatives, tertiary amines, Lewis acid complexes, such as boron trifluoride and boron trichloride and polymercaptans. Any epoxy-modified amine products, Mannich modified products, and Michael modified addition products of the hardeners described above may also be used. All of the above mentioned curatives may be used either alone or in any combination.

In one embodiment, the hardener is a multifunctional amine. The term “multifunctional amine” as used herein refers to an amine having at least two primary and/or secondary amino groups in a molecule. For example, the multifunctional amine may be an aromatic multifunctional amine having two amino groups bonded to benzene at any one of ortho, meta and para positional relations, such as phenylenediamine, xylenediamine, 1,3,5-triaminobenzene, 1,2,4-triaminobenzene and 3,5-diaminobenzoic acid, an aliphatic multifunctional amine such as ethylenediamine and propylenediamine, an alicyclic multifunctional amine such as 1,2-diaminocyclohexane, 1,4-diaminocyclohexane, piperazine, 1,3-bispiperidylpropane and 4-aminomethylpiperazine, and the like. These multifunctional amines may be used alone or in a mixture thereof.

Exemplary aromatic amines include, but are not limited to 1,8 diaminonaphthalene, m-phenylenediamine, diethylene toluene diamine, diaminodiphenylsulfone, diaminodiphenylmethane, diaminodiethyldimethyl diphenylmethane, 4,4′-methylenebis(2,6-diethylaniline), 4,4′-methylenebis(2-isopropyl-6-methylaniline), 4,4′-methylenebis(2,6-diisopropylaniline), 4,4′-[1,4-phenylenebis(1-methyl-ethylindene)]bisaniline, 4,4′-[1,3 -phenylenebis(1-methyl-ethylindene)]bisaniline, 1,3-bis(3-aminophenoxy)benzene, bis-[4-(3-aminophenoxy)phenyl]sulfone, bis-[4-(4-aminophenoxy)phenyl]sulfone, 2,2′-bis[4-(4-aminophenoxy)phenyl]propane and bis(4-amino-2-chloro-3,5-diethylphenyl)methane. Furthermore, the aromatic amines may include heterocyclic multifunctional amine adducts as disclosed in U.S. Pat. Nos. 4,427,802 and 4,599,413, which are both hereby incorporated by way of reference in their entirety.

Examples of cyclic amines include, but are not limited to bis(4-amino-3-methyldicyclohexyl)methane, diaminodicyclohexylmethane, bi s(aminomethyl)cyclohexane, N-aminoethylpyrazine, 3,9-bis(3-aminopropyl)-2,4,8,10-tetraoxaspiro(5,5)undecane, m-xylenediamine, isophoronediamine, menthenediamine, 1,4-bis(2-amino-2-methylpropyl) piperazine, N,N′-dimethylpiperazine, pyridine, picoline, 1,8-diazabicyclo[5,4,0]-7-undecene, benzylmethylamine, 2-(dimethylaminomethyl)-phenol, 2-methylimidazole, 2-phenylimidazole, and 2-ethyl-4-methylimidazole.

Exemplary aliphatic amines include, but are not limited to diethylenetriamine, triethylenetetramine, tetraethylenepentamine, 3-(dimethylamino)propylamine, 3-(diethylamino)-propylamine, 3-(methylamino)propylamine, tris(2-aminoethyl)amine; 3-(2-ethylhexyloxy)propylamine, 3-ethoxypropylamine, 3-methoxypropylamine, 3-dibutylamino)propylamine, and tetramethyl-ethylenediamine; ethylenediamine; 3,3′-iminobis(propylamine), N-methyl-3,3′-iminobis(propylamine); allylamine, diallylamine, triallylamine, polyoxypropylenediamine, and polyoxypropylenetriamine.

Exemplary alkyl amines include, but are not limited to methylamine, ethylamine, propylamine, isopropylamine, butylamine, sec-butylamine, t-butylamine, n-octylamine, 2-ethylhexylamine, dimethylamine, diethylamine, dipropylamine, diisopropylamine, dibutylamine, di-sec-butylamine, di-t-butylamine, di-n-octylamine and di-2-ethylhexylamine.

Exemplary acid anhydrides include, but are not limited to, cyclohexane-1,2-dicarboxylic acid anhydride, 1-cyclohexene-1,2-dicarboxylic acid anhydride, 2-cyclohexene-1,2-dicarboxylic acid anhydride, 3-cyclohexene-1,2-dicarboxylic acid anhydride, 4-cyclohexene-1,2-dicarboxylic acid anhydride, 1-methyl-2-cyclohexene-1,2-dicarboxylic acid anhydride, 1-methyl-4-cyclohexene-1,2-dicarboxylic acid anhydride, 3-methyl-4-cyclohexene-1,2-dicarboxylic acid anhydride, 4-methyl-4-cyclohexene-1,2-dicarboxylic acid anhydride, dodecenylsuccinic anhydride, succinic anhydride, 4-methyl-1-cyclohexene-1,2-dicarboxylic acid anhydride, phthalic anhydride, hexahydrophthalic anhydride, nadic methyl anhydride, dodecenylsuccinic anhydride, tetrahydrophthalic anhydride, maleic anhydride, pyromellitic dianhydride, trimellitic anhydride, benzophenonetetracarboxylic dianhydride, bicyclo[2.2.1]hept-5-ene-2,3-dicarboxylic anhydride, methylbicyclo[2.2.1]hept-5 -ene-2,3 -dicarboxylic anhydride, bicyclo[2.2.1]hept-5-ene-2,3-dicarboxylic anhydride, dichloromaleic anhydride, chlorendic anhydride, tetrachlorophthalic anhydride and any derivative or adduct thereof.

Exemplary imidazoles include, but are not limited to, imidazole, 1-methylimidazole, 2-methylimidazole, 2-ethylimidazole, 2-i sopropylimidazole, 2-n-propylimidazole, 2-undecylimidazole, 2- heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-isopropyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4-methyl-5-hydroxymethylimidazole, 2-phenylimidazole, 2-phenyl-4,5-dihydroxymethylimidazole, 1,2-phenyl-4-methyl-5-hydroxymethylimidazole, 1-dodecyl-2-methylimidazole and 1-cyanoethyl-2-phenyl-4,5-di(2-cyanoethoxy)methylimidazole.

Exemplary substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and cyanoguanidine (dicyandiamide). Representatives of guanamine derivatives which may be mentioned are alkylated benzoguanamine resins, benzoguanamine resins or methoxymethylethoxymethylbenzoguanamine. Substituted ureas may include p-chlorophenyl-N, N-dimethylurea (monuron), 3-phenyl-1,1-dimethylurea (fenuron) or 3,4-dichlorophenyl-N,N-dimethylurea (diuron).

Exemplary tertiary amines include, but are not limited to, trimethylamine, tripropylamine, triisopropylamine, tributylamine, tri-sec-butylamine, tri-t-butylamine, tri-n-octylamine, N,N-dimethylaniline, N,N-dimethyl-benzylamine, pyridine, N-methylpiperidine, N-methylmorpholine, N,N-dimethylaminopyridine, derivatives of morpholine such as bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, and tris(2-(4-morpholino)propyl)amine, diazabicyclooctane (DABCO), and heterocyclic compounds having an amidine bonding such as diazabicyclono.

Amine-epoxy adducts are well-known in the art and are described, for example, in U.S. Pat. Nos. 3,756,984, 4,066,625, 4,268,656, 4,360,649, 4,542,202, 4,546,155, 5,134,239, 5,407,978, 5,543,486, 5,548,058, 5,430,112, 5,464,910, 5,439,977, 5,717,011, 5,733,954, 5,789,498, 5,798,399 and 5,801,218, each of which is incorporated herein by reference in its entirety. Such amine-epoxy adducts are the products of the reaction between one or more amine compounds and one or more epoxy compounds. Preferably, the adduct is a solid which is insoluble in the epoxy resin at room temperature, but which becomes soluble and functions as an accelerator to increase the cure rate upon heating. While any type of amine can be used (with heterocyclic amines and/or amines containing at least one secondary nitrogen atom being preferred), imidazole compounds are particularly preferred. Illustrative imidazoles include 2-methyl imidazole, 2,4-dimethyl imidazole, 2-ethyl-4-methyl imidazole, 2-phenyl imidazole and the like. Other suitable amines include, but are not limited to, piperazines, piperidines, pyrazoles, purines, and triazoles. Any kind of epoxy compound can be employed as the other starting material for the adduct, including mono-functional, and multi-functional epoxy compounds such as those described previously with regard to the epoxy resin component.

In one embodiment, the curable resin composition of the present disclosure may contain the hardener in an amount of between about 10 wt. % to about 60 wt. %, or between about 20 wt. % to about 50 wt. %, or between about 30 wt. % to about 50 wt. %, based on the total weight of the curable resin composition. In another embodiment, the curable resin composition of the present disclosure may contain the hardener in an amount of between about 5 wt. % to about 50 wt. %, or between about 10 wt. % to about 45 wt. %, or between about 20 wt. % to about 40 wt. %, based on the total weight of the curable resin composition.

In still another embodiment, the curable resin composition includes 4,4′-methylene-bis-(3-chloro-2,6-diethyl-aniline) as the hardener in an amount of between about 30 wt. % to about 55 wt. % or between about 40 wt. % to about 50 wt. %, based on the total weight of the curable resin composition. In still another embodiment, the hardener includes about 25 to about 100 parts of 4,4′-methylene-bis-(3-chloro-2,6-diethyl-aniline) and 0 to about 75 parts of an aromatic amine or an aliphatic amine, based on 100 parts of hardener.

In yet another embodiment, the curable resin composition may also contain one or more other additives which are useful for their intended uses. For example, the optional additives useful may include, but are not limited to, diluents, stabilizers, surfactants, flow modifiers, release agents, matting agents, degassing agents, thermoplastic particles (for e.g. carboxyl terminated liquid butadiene acrylonitrile rubber (CTBN), acrylic terminated liquid butadiene acrylonitrile rubber (ATBN), epoxy terminated liquid butadiene acrylonitrile rubber (ETBN), liquid epoxy resin (LER) adducts of elastomers and preformed core-shell rubbers), curing initiators, curing inhibitors, wetting agents, processing aids, fluorescent compounds, UV stabilizers, antioxidants, impact modifiers, corrosion inhibitors, tackifiers, high density particulate fillers (for e.g. various naturally occurring clays, such as kaolin, bentonite, montmorillonite or modified montmorillonite, attapulgate and Buckminsterfuller's earth; other naturally occurring or naturally derived materials, such as mica, calcium carbonate and aluminum carbonate; various oxides, such as ferric oxide, titanium dioxide, calcium oxide and silicon dioxide (for e.g., sand); various man-made materials, such as precipitated calcium carbonate; and various waste materials such as crushed blast furnace slag), conducting particles (for e.g. silver, gold, copper, nickel, aluminum and conducting grades of carbon and carbon nanotubes) and mixtures thereof.

When present, the amount of additives included in the curable resin composition may be in an amount of at least about 0.5wt. %, or at least 2wt. %, or at least 5wt. % or at least 10 wt. %, based on the total weight of the curable resin composition. In other embodiments, the amount of additives included in the curable resin composition may be no more than about 30 wt. %, or no more than 25 wt. %, or no more than 20 wt. % or no more than 15 wt. %, based on the total weight of the curable resin composition.

The curable resin composition may be prepared for example, by premixing individual components and then mixing these premixes, or by mixing all of the components together using customary devices, such as a stirred vessel, stirring rod, ball mill, sample mixer, static mixer, high shear mixer, ribbon blender or by hot melting.

Thus, according to another embodiment, the curable resin composition of the present disclosure may be prepared by mixing together from about 10 wt. % to about 90 wt. % of the thermoset resin and from about 1 wt. % to about 25 wt. % of the toughener component and from about 10 wt. % to about 60 wt. % of the hardener, where the wt. % is based on the total weight of the curable resin composition.

Thermosets can be formed from the curable resin composition of the present disclosure by mixing the thermoset resin, toughener component and hardener at proportions as described above and then curing the curable resin composition. In some embodiments, it may be generally necessary to heat the composition to an elevated temperature to obtain a rapid cure. In a molding process, such as a process for making fiber-reinforced composite articles, the curable resin composition may be introduced into a mold, which may, together with any reinforcing fibers and/or inserts as may be contained in the mold, be preheated. The curing temperature may be, for example, from about 60° C. to up to about 190° C. When a long (at least 30 seconds, preferably at least 40 seconds) gel time is desirable, the curing temperature preferably is not greater than 130° C. When both a long gel time and a short demold time is wanted, a suitable curing temperature may be about 80° C. to about 120° C., preferably 95 to 120° C. and especially 105 to 120° C. In some embodiments, it may be preferred to continue the cure until the resulting composite attains a glass transition temperature in excess of the cure temperature. The glass transition temperature at the time of demolding may be at least about 100° C., or at least about 110° C., or at least about 115° C. or even at least about 120° C. Demold times at cure temperatures of about 95° C. to about 120° C., especially about 105° C. to about 120° C., are typically 350 seconds or less, preferably are 300 seconds or less and more preferably 240 seconds or less.

Accordingly, for fabricating high-performance composite materials and prepregs, reinforcing fibers may be combined with the curable resin composition to form a fiber-reinforced resin composition and this composition may then be cured. The curable resin composition may be combined with the reinforcing fibers in accordance with any of the known prepreg manufacturing techniques. The reinforcing fibers may be fully or partially impregnated with the curable resin composition. In an alternative embodiment, the curable resin composition may be applied to the reinforcing fibers as a separate layer, which is proximal to, and in contact with, the reinforcing fibers, but does not substantially impregnate the reinforcing fibers. The prepreg is typically covered on both sides with a protective film and rolled up for storage and shipment at temperatures that are typically kept well below room temperature to avoid premature curing. Any of the other prepreg manufacturing processes and storage/shipping systems may be used if desired.

Suitable reinforcing fibres may include, but are not limited to, fibers having a high tensile strength, such as greater than 500 ksi (or 3447 MPa). Fibers that are useful for this purpose include carbon or graphite fibers, glass fibers and fibers formed of silicon carbide, alumina, boron, quartz, and the like, as well as fibers formed from organic polymers, such as for example polyolefins, poly(benzothiazole), poly(benzimidazole), polyarylates, poly(benzoxazole), aromatic polyamides, polyaryl ethers and the like, and may include mixtures having two or more such fibers. Preferably, the fibers are selected from glass fibers, carbon fibers and aromatic polyamide fibers. The reinforcing fibers may be used in the form of discontinuous or continuous tows made up of multiple filaments, as continuous unidirectional or multidirectional tapes, or as woven, noncrimped, or nonwoven fabrics. The woven form may be selected from plain, satin, or twill weave style. The noncrimped fabric may have a number of plies and fiber orientations.

The reinforcing fibers may be sized or unsized and may be present at a content of about 5 wt. % to about 35 wt. % by weight, preferably at least 20 wt. %, based on the total weight of the fiber-reinforced resin composition. For structural applications, it is preferred to use continuous fibers, for example glass or carbon fibers, especially at 30% to 70% by volume, more especially 50% to 70% by volume, based on the total volume of the fiber-reinforced resin composition.

To form a fiber-reinforced composite article, a plurality of curable, flexible prepreg plies may be laid up on a tool in a stacking sequence to form a prepreg layup. The prepreg plies within the layup may be positioned in a selected orientation with respect to one another, for e.g. 0°, +45°, 90°, etc. Prepreg layups may be manufactured by techniques that may include, but are not limited to, hand lay-up, automated tape layup (ATL), advanced fiber placement (AFP), and filament winding.

Each prepreg is composed of a sheet or layer of reinforcing fibers that has been impregnated with the curable resin composition within at least a portion of their volume. In one embodiment, the prepreg has a fiber volume fraction of between about 0.50 to 0.60 on the basis of the total volume of the prepreg.

The prepreg useful for manufacturing aerospace structures is usually a resin-impregnated sheet of unidirectional reinforcing fibers, typically, carbon fibers, which is often referred to as “tape’ or “unidirectional tape’ or “unitape’. The prepregs may be fully impregnated prepregs or partially impregnated prepregs. The curable resin composition impregnating the reinforcing fibers may be in a partially cured or uncured state.

Typically, the prepreg is in a pliable or flexible form that is ready for laying up and molding into a three-dimensional configuration, followed by curing into a final fiber-reinforced composite part. This type of prepreg is particularly suitable for manufacturing load-bearing structural parts, such as wings, fuselages, bulkheads and control surfaces of aircrafts. Important properties of the cured prepregs are high strength and stiffness with reduced weight.

As noted above, curing of the prepreg layup is generally carried out at elevated temperatures up to about 190° C., preferably in the range of about 170° C. to about 190° C., and with use of elevated pressure to restrain deforming effects of escaping gases, or to restrain void formation, suitably at pressure of up to 10 bar (1 MPa), preferably in the range of 3 bar (0.3 MPa) to 7 bar (0.7 MPa). Preferably, the cure temperature is attained by heating at up to 5° C./min, for example 2° C./min to 3° C./min and is maintained for the required period of up to 9 hours, preferably up to 6 hours, for example 2 hours to 4 hours. The use of a catalyst in the curable resin composition may allow even lower cure temperatures. Pressure can be released throughout, and temperature can be reduced by cooling at up to 5° C./min, for example up to 3° C./min. Post-curing at temperatures in the range of about 190° C. up to about 350° C. and at atmospheric pressure may be performed, employing suitable heating rates.

Thus, according to one embodiment there is generally provided a process for producing a fiber-reinforced composite article including the steps of: (i) contacting the reinforcing fibers with the curable resin composition in a mold to coat and/or impregnate the reinforcing fibers; and (ii) curing the coated and/or impregnated reinforcing fibers at a temperature of at least about 60° C. or at least about 120° C. to about 190° C.

Coating and/or impregnation may be affected by either a wet method or hot melt method. In the wet method, the curable resin composition is first dissolved in a solvent to lower viscosity, after which coating and/or impregnation of the reinforcing fibers is effected and the solvent is evaporated off using an oven or the like. In the hot melt method, coating and/or impregnation may be effected by directly coating and/or impregnating the reinforcing fibers with the curable resin composition which has been heated to reduce its viscosity, or alternatively, a coated film of the curable resin composition may first be produced on release paper or the like, and the film placed on one or both sides of the reinforcing fibers and heat and pressure applied to effect coating and/or impregnation.

In yet another embodiment there is generally provided a method for producing a fiber-reinforced composite article in a RIM system. The process includes the steps of: a) introducing a fiber preform comprising reinforcing fibers into a mold; b) injecting the curable resin composition into the mold; c) allowing the curable resin composition to impregnate the fiber preform; and d) heating the impregnated fiber preform at a temperature of least about 60° C. or at least about 120° C. for a period of time to produce an at least partially cured fiber-reinforced composite article; and e) optionally subjecting the partially cured fiber-reinforced composite article to post curing operations at a temperature of from about 100° C. to about 350° C.

In an alternative embodiment, the present disclosure generally provides a method for producing a fiber-reinforced composite article in a VaRTM system. The process includes the steps of: a) introducing a fiber preform comprising reinforcing fibers into a mold; b) injecting the curable resin composition into the mold; c) reducing the pressure within the mold; d) maintaining the mold at about the reduced pressure; e) allowing the curable resin composition to impregnate the fiber preform; f) heating the impregnated fiber preform at a temperature of at least about 60° C. or at least about 120° C. for a period of time to produce an at least partially cured fiber-reinforced composite article; and e) optionally subjecting the at least partially cured fiber-reinforced composite article to post curing operations at a temperature of from about 100° C. to about 350° C.

The process of the invention is useful for making a wide variety of fiber-reinforced composite articles, including various types of aerospace structures and automotive, rail and marine structures. Examples of aerospace structures include primary and secondary aerospace structural materials (wings, fuselages, bulkheads, flap, aileron, cowl, fairing, interior trim, etc.), rocket motor cases, and structural materials for artificial satellites. Examples of automotive structures include vertical and horizontal body panels (fenders, door skins, hoods, roof skins, decklids, tailgates and the like) and automobile and truck chassis components.

### EXAMPLES

Various curable resin compositions were prepared and then cured. Various thermal and mechanical properties were determined according to techniques known to those skilled in the art. The results are shown below in Tables 1 and 2:

TABLE 1

| | Equivalent | | | |
|---|---|---|---|---|
| | Weight of | | | |
| | Component | Example 1 | Example 2 | Example 3 |
| ARALDITE ® | 114.0 | | 8.31 | 7.83 |
| MY 721 Epoxy | | | | |
| ARALDITE ® | 101.0 | 40.51 | 40.04 | 37.70 |
| MY 0510 Epoxy | | | | |
| ARALDITE ® | 161.5 | 9.56 | | |
| PY 306 Epoxy | | | | |
| Polyethersulfone | | | | 1.62 |
| Clearstrength ® | | 6.20 | 7.06 | 6.66 |
| XT100 Multi- | | | | |
| stage Polymer | | | | |
| 4,4′-methylenebis | 95.0 | 43.73 | 44.59 | 46.19 |
| (3-chloro-2,6- | | | | |
| diethyl-aniline) | | | | |
| hardener | | | | |
| Total: | | 100.0 | 100.0 | 100.0 |
| Total Toughener | | 6.20 | 7.06 | 8.28 |
| (%) | | | | |
| Epoxy:Amine | | 1.000 | 1.000 | 0.909 |
| | Target | 9720-6-15 | 9720-6-16 | 9720-6-18 |
| Latency | At 80° C. and | Yes | Yes | Yes |
| | 120° C. | | | |
| Cure | 180° C./ | 180° C./ | 180° C./ | 180° C./ |
| | 3 hr | 3 hr | 3 hr | 3 hr |
| Tg (Dry/Hw) | >179/>163 | 191/167 | 204/178 | 204/178 |
| (° C.) | | | | |
| G1c (J/m²) | >280 | 631 | 656 | 453 |
| CAI (ksi) | >33 | 33.5 | 33.0 | 37.1 |

TABLE 2

| | Equivalent | | |
|---|---|---|---|
| | Weight of | | |
| | Component | Example 4 | Example 5 |
| ARALDITE ® MY | 114.0 | 8.31 | 8.17 |
| 721 Epoxy | | | |
| ARALDITE ® MY | 101.0 | 40.04 | 39.35 |
| 0510 Epoxy | | | |
| Polyethersulfone | | | 1.69 |
| Clearstrength ® | | 7.06 | 6.95 |
| XT 100 Multistage | | | |
| Polymer | | | |
| 4,4′-methylenebis(3- | 95.0 | 44.59 | 43.83 |
| chloro-2,6-diethyl- | | | |
| aniline) hardener | | | |
| Total: | | 100 | 100 |
| Equivalent Weight | | 118.1 | 121.8 |
| of Mixture | | | |
| PHR | | 80.5 | 78.0 |
| % Amine | | 44.6 | 43.8 |
| % Epoxy | | 55.4 | 56.2 |
| Epoxy:Amine Molar | | 1 | 1 |
| Ratio | | | |
| % Toughener | | 7.1 | 8.6 |
| DSC Onset, ° C. | | 227 | 225 |
| DSC Peak, ° C. | | 272 | 269 |
| DSC, Enthalpy J/g | | 473 | 490 |
| Cure Schedule | | | |
| Initial T_{g}, DMA | | 204 | 204 |
| 48 Hr boiling water | | | |
| Water Uptake | | | |
| Flex, strain, % | | 8.4 | 7.7 |
| Flex. strength, psi | | 20643 | 19979 |
| Flex, modulus, ksi | | 430 | 433 |
| Tensile elong., % | | 5.5 | 5.6 |
| Tensile strength, psi | | 11562 | 12078 |
| Tensile modulus, ksi | | 412 | 417 |
| Fracture toughness, | | 656 | 453 |
| G1C | | | |
| Fracture toughness, | | 1.46 | 1.1 |
| K1C | | | |

From the results, it can be seen that the compression after impact (CAI) and glass transition temperature for inventive Examples 3 exceeds those for Examples 1 and 2, thus demonstrating the synergistic effect of the toughener component containing the multistage polymer and thermoplastic toughener.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

1. A curable resin composition comprising (a) a thermoset resin, (b) a toughener component comprising a multistage polymer and a thermoplastic toughener, and (c) a hardener, wherein the multistage polymer is in the form of polymer particles and wherein said polymer particles have a multilayer structure including at least one layer (or stage) (A) comprising a polymer (A1) having a glass transition temperature below about 10° C., and at least another layer (or stage) (B) comprising a polymer (B1) having a glass transition temperature over about 30° C.

2. The curable resin composition of claim 1, wherein the thermoset resin is an epoxy resin.

3. The curable resin composition of claim 2, wherein the epoxy resin is selected from a difunctional epoxy resin, a trifunctional epoxy resin, a tetrafunctional epoxy resin and a mixture thereof.

4. The curable resin composition of claim 1, wherein the thermoset resin is a benzoxazine.

5. The curable resin composition of claim 1, wherein the thermoplastic toughener is polyethersulfone.

6. The curable resin composition of claim 1, wherein the hardener comprises 4,4′-methylene-bis-(3-chloro-2,6-diethyl-aniline).

7. A curable resin composition comprising
(a) about 50 wt. % to about 95 wt. % of a thermoset resin,
(b) about 1 wt. % to about 25 wt. % of a toughener component comprising a multistage polymer and a thermoplastic toughener, and
(c) about 5 wt. % to about 50 wt. % of a hardener, where the wt. % is based on the total weight of the curable resin composition, wherein the multistage polymer is in the form of polymer particles and wherein said polymer particles have a multilayer structure including at least one layer (or stage) (A) comprising a polymer (A1) having a glass transition temperature below about 10° C., and at least another layer (or stage) (B) comprising a polymer (B1) having a glass transition temperature over about 30° C.

8. The curable resin composition of claim 7, wherein the toughener component comprises about 5 wt. % to about 15 wt. % of the multistage polymer and about 0.1 wt. % to about 10 wt. % of the thermoplastic toughener.

9. The curable resin composition of claim 7, wherein the hardener comprises about 25 parts to about 100 parts of 4,4′-methylene-bis-(3-chloro-2,6-diethyl-aniline) and from about 0 parts to about 75 parts of an aromatic amine or an aliphatic amine.

10. A fiber-reinforced resin composition comprising reinforcing fibers and the curable resin composition of claim 1.

11. The fiber-reinforced resin composition of claim 10, wherein the reinforcing fibers are selected from graphite fibers, glass fibers, fibers formed of silicon carbide, fibers formed of alumina, fibers formed of boron, fibers formed of quartz, fibers formed from an organic polymer and a mixture thereof.

12. The fiber-reinforced resin composition of claim 11, wherein the reinforcing fibers are present in an amount of about 5 wt. % to about 35 wt. % by weight, based on the total weight of the fiber-reinforced resin composition.

13. A method of producing a fiber-reinforced composite article including the steps of: (i) contacting reinforcing fibers with the curable resin composition of claim 1 to coat and/or impregnate the reinforcing fibers; and (ii) curing the coated and/or impregnated reinforcing fibers at a temperature of at least about 60° C.

14. A fiber-reinforced composite article produced according to the method of claim 13.

15. The fiber-reinforced composite article of claim 14, wherein the composite article is a primary or secondary aerospace structural material.

16. A method of producing a fiber-reinforced composite article in a RIM system including the steps of: a) introducing a fiber preform comprising reinforcing fibers into a mold; b) injecting the curable resin composition of claim 1 into the mold; c) allowing the curable resin composition to impregnate the fiber preform; d) heating the impregnated fiber preform at a temperature of least about 60° C. for a period of time to produce an at least partially cured fiber-reinforced composite article; and e) optionally subjecting the partially cured fiber-reinforced composite article to post curing operations at a temperature of from about 100° C. up to about 350° C.

17. A method of producing a fiber-reinforced composite article in a VaRTM system including the steps of: a) introducing a fiber preform comprising reinforcing fibers into a mold; b) injecting the curable resin composition of claim 1 into the mold; c) reducing the pressure within the mold; d) maintaining the mold at about the reduced pressure; e) allowing the curable resin composition to impregnate the fiber preform; f) heating the impregnated fiber preform at a temperature of at least about 60° C. for a period of time to produce an at least partially cured fiber-reinforced composite article; and e) optionally subjecting the at least partially cured fiber-reinforced composite article to post curing operations at a temperature of from about 100° C. to about 350° C.
